(19) United States
(12) Patent Application Publication
(10) Pub. No.: US 2011/0091741 A1
(43) Pub. Date: Apr. 21, 2011

(54) METHOD FOR PRODUCING TINNED STEEL SHEET, TINNED STEEL SHEET, AND CHEMICAL CONVERSION SOLUTION

(75) Inventors: Takeshi Suzuki, Tokyo (JP); Norihiko Nakamura, Tokyo (JP); Hiroki Iwasa, Tokyo (JP)

(73) Assignee: JFE STEEL CORPORATION, Tokyo (US)

(21) Appl. No.: 12/990,839

(22) PCT Filed: May 11, 2009
(86) PCT No.: PCT/JP2009/059101

§ 371 Date: Nov. 3, 2010

(30) Foreign Application Priority Data
May 12, 2008 (JP) 2008-124856
Apr. 22, 2009 (JP) 2009-103900

(51) Int. Cl. C25D 5/26; C25D 5/50; C25D 11/36; B32B 15/01

(52) U.S. Cl. 428/648; 205/301

(57) ABSTRACT

A chemical conversion solution contains greater than 18 to 200 g/L or less of aluminum phosphate monobasic and has a pH of 1.5 to 2.4. A method for producing a tinned steel sheet includes forming an Sn-containing plating layer on at least one surface of a steel sheet such that the mass per unit area of Sn is 0.05 to 20 g/m², immersing the steel sheet in the chemical conversion solution or cathodically electrolyzing the steel sheet at a current density of 10 A/dm² or less in the chemical conversion solution; and drying the steel sheet to form a chemical conversion coating.

### RELATED APPLICATIONS

This is a §371 of International Application No. PCT/JP2009/059101, with an international filing date of May 11, 2009 (WO 2009/139480 A1, published Nov. 19, 2009), which is based on Japanese Patent Application Nos. 2008-124856, filed May 12, 2008, and 2009-103900, filed Apr. 22, 2009, the subject matter of which is incorporated by reference.

### TECHNICAL FIELD

This disclosure relates to tinned steel sheets used for DI cans, food cans, beverage cans, and other cans. The disclosure particularly relates to a method for producing a tinned steel sheet having a chemical conversion coating, disposed thereon, containing no chromium (Cr); a tinned steel sheet; and a chemical conversion solution.

### BACKGROUND

Tinned steel sheets referred to as “tinplate” have been widely used as surface-treated steel sheets for cans. In the tinned steel sheets, chromate coatings are formed on tin plating layers by chromating in such a manner that steel sheets are immersed in aqueous solutions containing hexavalent chromium compound such as bichromic acid or are electrolyzed in the aqueous solutions. This is because the formation of the chromate coatings prevents the surface oxidation of the tin plating layers, which are likely to be oxidized during long-term storage, to suppress the deterioration of appearance (yellowing) and also prevents cohesive failure due to the growth of tin (Sn) oxide coatings to secure the adhesion (hereinafter simply referred to as “paint adhesion”) with organic resins such as paints in the case of painting the tinned steel sheets.

In the light of recent environmental issues, efforts to restrict the use of Cr are being made in every field. For tinned steel sheets for cans, several chemical conversion techniques alternative to chromating have been proposed. For example, Japanese Examined Patent Application Publication No. 55-24516 discloses a method for surface-treating a tinned steel sheet. In the method, a chemical conversion coating is formed in such a manner that the tinned steel sheet is subjected to direct-current electrolyzing in a phosphate solution using the tinned steel sheet as a cathode. Japanese Examined Patent Application Publication No. 58-41352 discloses a chemical conversion solution which contains phosphoric ions, tin ions, and one or more of a chlorate and a bromate and which has a pH of 3 to 6. Japanese Unexamined Patent Application Publication No. 49-28539 discloses a method for surface-treating tinplate. In that method, one or more of calcium phosphate, magnesium phosphate, and aluminum phosphate are applied to tinplate to form a coating with a thickness corresponding to 15 μg/cm² or less. Japanese Unexamined Patent Application Publication No. 2005-29808 discloses a surface-treated steel sheet for containers. In the surface-treated steel sheet, an iron-nickel (Fe—Ni) diffusion layer, an Ni—Sn alloy layer, and a non-alloyed Sn layer are arranged on a surface of a steel sheet in that order and a phosphoric acid coating having a mass per unit area of 1 to 100 mg/m² in terms of phosphorus (P) is disposed on the non-alloyed Sn layer.

The chemical conversion coatings disclosed in JP '516, JP '352, JP '539 and JP '808 are less capable of preventing the deterioration of appearance and the reduction of paint adhesion due to the surface oxidation of tin plating layers as compared to conventional chromate coatings.

Japanese Unexamined Patent Application Publication No. 2007-239091 discloses a method for producing a tinned steel sheet. In that method, after a steel sheet is tinned, the tinned steel sheet is immersed in a chemical conversion solution containing tin ions and phosphoric ions or cathodically electrolyzed in the chemical conversion solution and a chemical conversion coating is then formed by heating the tinned steel sheet to a temperature of 60° C. to 200° C., whereby the deterioration of appearance and the reduction of paint adhesion due to the surface oxidation of a tin plating layer can be prevented.

The chemical conversion coating disclosed in JP '091 has performance equal to or better than that of conventional chromate coatings. However, that chemical conversion coating has a problem that the cost of forming this chemical conversion coating is high because expensive stannous chloride, stannic chloride, tin sulfate, or the like is used as a tin ion source to form this chemical conversion coating and a heating unit used subsequently to chemical conversion is necessary.

It could therefore be helpful to provide a method for producing a tinned steel sheet which is capable of preventing the deterioration of appearance and the reduction of paint adhesion due to the surface oxidation of a tin plating layer without using Cr and which can be subjected to chemical conversion at low cost, a tinned steel sheet, and a chemical conversion solution.

### SUMMARY

We conducted intensive studies on tinned steel sheets capable of preventing the deterioration of appearance and the reduction of paint adhesion due to the surface oxidation of tin plating layers without using Cr and which can be subjected to chemical conversion at low cost. As a result, we found that it is effective that a chemical conversion coating is formed in such a manner that after an Sn-containing plating layer is formed such that the mass of Sn per unit area is 0.05 to 20 g/m², the Sn-containing plating layer is immersed in a chemical conversion solution which contains greater than 18 to 200 g/L or less of aluminum phosphate monobasic and which has a pH of 1.5 to 2.4 or is cathodically electrolyzed in the chemical conversion solution.

We found a method for producing a tinned steel sheet. The method includes forming an Sn-containing plating layer on at least one surface of a steel sheet such that the mass per unit area of Sn is 0.05 to 20 g/m², immersing the steel sheet in a chemical conversion solution which contains greater than 18 to 200 g/L or less of aluminum phosphate monobasic and which has a pH of 1.5 to 2.4 or cathodically electrolyzing the steel sheet at a current density of 10 A/dm² or less in the chemical conversion solution, and drying the steel sheet to form a chemical conversion coating.

The Sn-containing plating layer is preferably a plating layer consisting of a Sn layer or a plating layer consisting of an Fe—Sn layer and a Sn layer deposited thereon. Drying is preferably performed at a temperature of lower than 60° C. Cathodic electrolyzing is preferably performed in such a manner that the temperature of the chemical conversion solution is adjusted to 70° C. or higher.

We also provide a tinned steel sheet produced by the method.

In the tinned steel sheet, the chemical conversion coating preferably has a mass per unit area of 1.5 to 10 mg/m² in terms of P and the mass ratio (Al/P) of Al to P in the chemical conversion coating is preferably 0.20 to 0.87.

Furthermore, we provide a chemical conversion solution, having a pH of 1.5 to 2.4, containing greater than 18 to 200 g/L or less of aluminum phosphate monobasic.

The following sheet can be produced: a tinned steel sheet which is capable of preventing the deterioration of appearance and the reduction of paint adhesion due to the surface oxidation of a tin plating layer without using Cr and which can be subjected to chemical conversion at low cost. A chemical conversion coating of a tinned steel sheet can be formed at a high line speed of 300 m/minute as is formed by current chromating.

### DETAILED DESCRIPTION

### (1) Formation of Tin-Containing Plating Layer

The following layer is formed on at least one surface of a cold-rolled steel sheet, made of low carbon steel or ultra-low carbon steel, for general cans: a tin-containing plating layer such as a plating layer (hereinafter referred to as the “Sn layer”) including a Sn layer; a plating layer (hereinafter referred to as the “Fe—Sn/Sn layer”) having a two-layer structure including an Fe—Sn layer and a Sn layer deposited thereon; a plating layer (hereinafter referred to as the “Fe—Sn—Ni/Sn layer”) having a two-layer structure including an Fe—Sn—Ni layer and a Sn layer deposited thereon; or a plating layer (hereinafter referred to as the “Fe—Ni/Fe—Sn—Ni/Sn layer”) having a three-layer structure including an Fe—Ni layer, an Fe—Sn—Ni layer, and a Sn layer, the Fe—Sn—Ni layer and the Sn layer being deposited on the Fe—Sn—Ni layer in that order.

In the Sn-containing plating layer, the mass per unit area of Sn needs to be 0.05 to 20 g/m². This is because when the mass per unit area thereof is less than 0.05 g/m² or greater than 20 g/m², the plating layer is likely to have low corrosion resistance or has an increased thickness to cause an increase in cost, respectively. The mass per unit area of Sn can be determined by coulometry or X-ray fluorescence surface analysis. The Sn-containing plating layer may be a continuous layer or a discontinuous layer with a dotted pattern.

The Sn-containing plating layer can be formed by a known process. The Sn-containing plating layer can be formed by the following procedure: for example, electroplating is performed using an ordinary tin phenolsulfonate plating bath, tin methanesulfonate plating bath, or tin halide plating bath such that the mass per unit area of Sn is 2.8 g/m²; a plating layer including an Fe—Sn layer and a Sn layer is formed in such a manner that reflowing is performed at a temperature not lower than the melting point of Sn, that is, a temperature of 231.9° C. or higher; cathodic electrolyzing is performed in a 10-15 g/L aqueous solution of sodium carbonate at a current density of 1 to 3 A/dm² such that an Sn oxide coating formed on the surface by reflowing is removed; and water-washing is then performed.

A Ni-containing layer which may be included in the Sn-containing plating layer is formed in such a manner that nickel plating is performed prior to tin plating and annealing is then performed as required or reflowing is performed subsequently to tin plating. Hence, a nickel plating unit and complex steps are necessary. Therefore, the Ni-containing layer is higher in cost than Ni-free layers. Thus, the Sn-containing plating layer is preferably an Ni-free layer such as the Sn layer or the Fe—Sn/Sn layer.

### (2) Formation of Chemical Conversion Coating

A chemical conversion coating is formed on the Sn-containing plating layer in such a manner that immersion is performed in a chemical conversion solution which contains greater than 18 to 200 g/L or less of aluminum phosphate monobasic and which has a pH of 1.5 to 2.4 or cathodic electrolyzing is performed at a current density of 10 A/dm² or less in the chemical conversion solution and drying is then performed. In this operation, water washing may be performed prior to drying.

The reason for using the chemical conversion solution, which contains greater than 18 to 200 g/L or less of aluminum phosphate monobasic, is as described below. When the concentration of aluminum phosphate monobasic is 18 g/L or less, the homogeneous dispersion of Al in the chemical conversion coating is low and the local excess in mass per unit area causes the deterioration of paint adhesion and/or corrosion resistance. When the concentration thereof is greater than 200 g/L, the stability of the chemical conversion solution is low and precipitates are formed in the chemical conversion solution to adhere to a tinned steel sheet, thereby causing the deterioration of appearance and/or the reduction of paint adhesion. The reason for limiting the pH of the chemical conversion solution to the range of 1.5 to 2.4 is as described below. When the pH thereof is less than 1.5, it is difficult to deposit a coating and a sufficient mass per unit area cannot be achieved even if the time for chemical conversion is significantly increased to several tens of seconds. When the pH thereof is greater than 2.4, it is difficult to control the mass per unit area because a precipitation reaction occurs quickly during cathodic electrolyzing and the mass per unit area varies significantly with respect to the variation of the current density. The pH thereof can be adjusted by adding an acid such as phosphoric acid or sulfuric acid or an alkali such as sodium hydroxide to the chemical conversion solution. The chemical conversion solution may further contain an accelerator such as FeCl₂, NiCl₂, FeSO₄, NiSO₄, sodium chlorate, or a nitrite; an etchant such as a fluorine ion; and a surfactant such as sodium lauryl sulfate or acetylene glycol.

Since current chromating is usually performed at a line speed of 300 m/minute or more and is extremely high in productivity, novel chemical conversion alternative to chromating can be preferably performed at at least the same line speed as that of current chromating. This is because an increase in time for the chemical conversion requires an increase in the size of a treatment tank and/or an increase in the number of tanks and therefore causes an increase in equipment cost and an increase in maintenance cost. To perform chemical conversion at a line speed of 300 m/minute or more without the modification of equipment, the time for the chemical conversion is preferably 2.0 seconds or less as is taken for current chromating and more preferably one second or less. To form the chemical conversion coating, immersion or cathodic electrolyzing needs to be performed in the chemical conversion solution. The current density during cathodic electrolyzing needs to be 10 A/dm² or less. This is because when the current density is greater than 10 A/dm², the variation range of the mass per unit area is large with respect to the variation of the current density and therefore it is difficult to stably secure the mass per unit area. Processes such as coating and anodic electrolyzing can be used to form the chemical conversion coating in addition to immersion and cathodic electrolyzing. For coating, uneven surface reactions are likely to occur and therefore uniform appearance is unlikely to be obtained. For anodic electrolyzing, a powdery coating is likely to precipitate and therefore the deterioration of appearance and/or paint adhesion is likely to be caused. Thus, these processes are inappropriate.

After immersion or cathodic electrolyzing is performed, drying is preferably performed at a temperature of lower than 60° C. This is because even if the drying temperature is lower than 60° C., the growth of the Sn oxide coating can be securely prevented and therefore no special heating unit is necessary in a producing method. The reason why the growth of the Sn oxide coating can be securely prevented at a reduced temperature of lower than 60° C. is not necessary clear but is probably that the introduction of an Al component into a coating leads to the formation of a complex phosphate coating with high barrier properties. The drying temperature is defined as the maximum temperature of the steel sheet during drying. The temperature of the chemical conversion solution is preferably adjusted to 70° C. or higher during cathodic electrolyzing. This is because when the temperature thereof is 70° C. or higher, the rate of deposition increases with an increase in temperature and therefore treatment can be performed at a higher line speed. However, when the temperature thereof is excessively high, the evaporation rate of water from the chemical conversion solution is large and therefore the composition of the chemical conversion solution varies with time. Thus, the temperature of the chemical conversion solution is preferably 85° C. or lower.

The chemical conversion coating, which is formed as described above, preferably has a mass per unit area of 1.5 to 10 mg/m² in terms of P. The mass ratio (Al/P) of Al to P in the chemical conversion coating is preferably 0.20 to 0.87. This is because when the mass per unit area in terms of P is less than 1.5 mg/m² or the mass ratio (Al/P) is less than 0.20, the effect of preventing the surface oxidation of the Sn-containing plating layer is insufficient and the deterioration of appearance and the reduction of paint adhesion are caused. When the mass per unit area in terms of P is greater than 10 mg/m², cohesive failure occurs in the chemical conversion coating and therefore the paint adhesion thereof is likely to be reduced. The upper limit of the mass ratio (Al/P) is 0.87 and is the maximum stoichiometrically derived from the case where the coating is entirely made of aluminum tertiary phosphate. The mass per unit area in terms of P can be determined by X-ray fluorescence surface analysis. The mass ratio (Al/P) can be determined in such a manner that the mass per unit area of P and that of Al are measured by X-ray fluorescence surface analysis.

To allow the mass per unit area in terms of P to reach 1.5 to 10 mg/m² in a short time, the concentration of aluminum phosphate monobasic is preferably 60 to 120 g/L. To allow the mass per unit area in terms of P to reach 1.5 to 10 mg/m² at a high line speed, cathodic electrolyzing is more preferable than immersion and the pH of the chemical conversion solution is forcibly increased in such a manner that protons located near the interface between the surface of a tin containing plating layer and the chemical conversion solution are consumed by generating gaseous hydrogen by cathodic electrolyzing.

The chemical conversion solution does not contain Sn, which is expensive. Therefore, a method for producing a tinned steel sheet that can be subjected to chemical conversion at low cost can be provided. The chemical conversion coating, which contains Al and P, is unavoidably contaminated with Sn migrating from the Sn-containing plating layer. In this case, the fact remains that substantially the same advantages can be obtained.

### EXAMPLES

The following sheets were used as raw materials:
Steel Sheets A that were low-carbon cold-rolled steel sheets with a thickness of 0.2 mm. Steel Sheets B that were low-carbon cold-rolled steel sheets with a thickness of 0.2 mm, both surfaces of the steel sheets were plated with nickel using a Watts bath to have a mass per unit area of 100 mg/m², and then annealed at 700° C. in an atmosphere containing 10 volume percent H₂ and 90 volume percent N₂, whereby nickel was diffused.

After Sn layers were formed on Steel Sheets A and B using a commercially available tin-plating bath such that the mass per unit area of Sn was as shown in Table 2, the Sn layers were reflowed at a temperature not lower than the melting point of Sn, whereby Sn-containing plating layers each including an Fe—Sn layer and a Sn layer were formed on Steel Sheets A and Sn-containing plating layers each including an Fe—Ni layer, an Fe—Ni—Sn layer, and a Sn layer were formed on Steel Sheets B. To remove surface Sn oxide coatings formed by reflowing, cathodic electrolyzing was performed at a current density of 1 A/dm² in a 10 g/L aqueous solution of sodium carbonate at a bath temperature of 50° C. After Steel Sheets A and B were washed with water and then each cathodically electrolyzed at a current density for a time as shown in Table 1 in a chemical conversion solution having an aluminum phosphate monobasic amount, pH, and temperature shown in Table 1, Steel Sheets A and B were washed with water, wrung with wringer rollers, and then dried at room temperature using an ordinary blower such that chemical conversion coatings were formed, whereby Sample Nos. 1 to 25 of tinned steel sheets were produced. In Sample No. 13, the chemical conversion coatings were formed in such a manner that immersion was performed at one second in a chemical conversion solution shown in Table 1 instead of cathodic electrolyzing. In Sample No. 12, the steel sheet was finally dried with hot air without using any blower in such a manner that the steel sheet is heated to 70° C. The pH of each chemical conversion solution shown in Table 1 was adjusted by the addition of orthophosphoric acid.

After each layer and coating were formed, the mass per unit area of Sn in the Sn-containing plating layers, the mass per unit area of the chemical conversion coatings in terms of P, the mass per unit area of the chemical conversion coatings in terms of Al, and the mass ratio (Al/P) were determined by the above-mentioned methods. The tinned steel sheets were evaluated for appearance immediately after production, the amount of the Sn oxide coatings and appearance after long-term storage, paint adhesion, and corrosion resistance by methods below.

Appearance Immediately after Production:

The appearance of each tinned steel sheet was visually observed immediately after production and then evaluated in accordance with standards below. A good appearance was rated as A or B.
A: a good appearance having no surface powdery precipitates and a metallic luster.
B: a good appearance having no surface powdery precipitates and a slightly whitish cast.
C: an uneven appearance having surface powdery precipitates locally present and a slightly whitish cast.
D: a whitish appearance having a large amount of surface powdery precipitates.
   Amount of Sn Oxide Coatings and Appearance after Long-Term Storage:

Each tinned steel sheet was stored for ten days in an atmosphere having a temperature of 60° C. and a relative humidity of 70%, the appearance thereof was visually observed, the amount of the Sn oxide coatings formed thereon was determined in such a manner that the Sn oxide coatings were electrolyzed at a current density of 25 μA/cm² in a 1/1000 N HBr electrolytic solution and the charge required for electrochemical reduction was determined, and the tinned steel sheet was evaluated in accordance with standards below. A tinned steel sheet having a small amount of Sn oxide coatings and a good appearance after long-term storage was rated as A or B.
A: a reduction charge of less than 2 mC/cm² and an excellent appearance (better than a chromated material).
B: a reduction charge of 2 to less than 3 mC/cm² and a good appearance (substantially equal to a chromated material).
C: a reduction charge of 3 to less than 5 mC/cm² and a slightly yellowish appearance.
D: a reduction charge of 5 mC/cm² or more and a clearly yellow appearance.

### Paint Adhesion:

After an epoxy-phenolic paint was applied to some of the tinned steel sheets immediately after production to have a mass per unit area of 50 mg/dm², the tinned steel sheet was baked at 210° C. for ten minutes. Two of the coated and baked tinned steel sheets were stacked such that a nylon adhesive film is sandwiched between the coated surfaces thereof. After the two tinned steel sheets were laminated under pressing conditions such as a pressure of 2.94×10⁵ Pa, a temperature of 190° C., and a pressing time of 30 seconds, the laminate was divided into specimens with a width of 5 mm. The specimens were measured for adhesion strength with a tensile tester and then evaluated in accordance with standards below. A tinned steel sheet with good paint adhesion was rated as A or B. The tinned steel sheets were stored for six months in a room temperature atmosphere and then evaluated for paint adhesion.
A: 19.6 N (2 kgf) or more (substantially equal to a chromated material for welded cans).
B: 3.92 N (0.4 kgf) to less than 19.6 N (substantially equal to a chromated material for welded cans).
C: 1.96 N (0.2 kgf) to less than 3.92 N.
D: less than 1.96 N (0.2 kgf).

### Corrosion Resistance:

After an epoxy-phenolic paint was applied to each tinned steel sheet to have a mass per unit area of 50 mg/dm², the tinned steel sheet was baked at 210° C. for ten minutes. The tinned steel sheet was immersed in a commercially available tomato juice at 60° C. for ten days and then visually evaluated whether a coating was stripped off and rust was present. A tinned steel sheet having good corrosion resistance was rated as A or B.
A: neither stripped coating nor rust.
B: no stripped coating and a slight number of rust spots.
C: no stripped coating and fine rust spots.
D: stripped coating and rust.

The results are shown in Table 2. Sample Nos. 1 to 18 of the tinned steel sheets produced by our method each have a good appearance immediately after production and after long-term storage, a small amount of Sn oxide coatings after long-term storage, excellent paint adhesion, and excellent corrosion resistance.

TABLE 1

| | | | | | | Cathodic | | | | |
|---|---|---|---|---|---|---|---|---|---|---|
| | | Chemical conversion solutions | | | | electrolyzing | | | | |
| | | Amount of | Amount of | | | (immersion) | | | | |
| | | aluminum | ortho- | | | conditions | | Drying | | |
| | Steel sheets | phosphate | phosphoric | | | Current | | | Attained | |
| Sample | for raw | monobasic | acid | | Temperature | density | Time | | temperature | |
| Nos. | materials | (g/L) | (g/L) | pH | (° C.) | (A/dm²) | (s) | System | (° C.) | Remarks |
| 1 | A | 19 | 8.5 | 1.74 | 70 | 4 | 1 | Blower | Room temperature | Inventive example |
| 2 | A | 19 | 4.2 | 1.97 | 70 | 4 | 1 | Blower | Room temperature | Inventive example |
| 3 | A | 19 | 3.0 | 2.08 | 70 | 4 | 1 | Blower | Room temperature | Inventive example |
| 4 | A | 54 | 3.0 | 2.12 | 80 | 6 | 1 | Blower | Room temperature | Inventive example |
| 5 | A | 19 | 20.0 | 1.60 | 70 | 4 | 2 | Blower | Room temperature | Inventive example |
| 6 | A | 19 | 8.5 | 1.74 | 50 | 4 | 1 | Blower | Room temperature | Inventive example |
| 7 | A | 60 | 8.5 | 1.80 | 50 | 4 | 0.5 | Blower | Room temperature | Inventive example |
| 8 | A | 80 | 8.5 | 1.80 | 50 | 4 | 0.5 | Blower | Room temperature | Inventive example |
| 9 | A | 120 | 8.5 | 1.80 | 50 | 4 | 0.5 | Blower | Room temperature | Inventive example |
| 10 | A | 200 | 8.5 | 1.80 | 50 | 4 | 0.5 | Blower | Room temperature | Inventive example |
| 11 | A | 19 | 8.5 | 1.74 | 70 | 4 | 1 | Blower | Room temperature | Inventive example |
| 12 | A | 60 | 8.5 | 1.80 | 50 | 4 | 0.5 | Hot air | 70 | Inventive example |
| | | | | | | | | drying | | |
| 13 | A | 60 | 8.5 | 1.80 | 70 | Immersion | 0.8 | Blower | Room temperature | Inventive example |
| 14 | A | 19 | 8.5 | 1.74 | 70 | 5 | 1 | Blower | Room temperature | Inventive example |
| 15 | B | 19 | 8.5 | 1.74 | 70 | 5 | 1 | Blower | Room temperature | Inventive example |
| 16 | A | 19 | 8.5 | 1.74 | 70 | 3 | 1 | Blower | Room temperature | Inventive example |
| 17 | B | 19 | 8.5 | 1.74 | 70 | 3 | 1 | Blower | Room temperature | Inventive example |
| 18 | A | 80 | 0 | 1.91 | 70 | 4 | 0.5 | Blower | Room temperature | Inventive example |
| 19 | B | 2 | 8.5 | 1.73 | 70 | 4 | 1 | Blower | Room temperature | Comparative example |
| 20 | A | 250 | 8.5 | 2.00 | 70 | 4 | 2 | Blower | Room temperature | Comparative example |
| 21 | A | 60 | 8.5 | 1.30 | 85 | 6 | 20 | Blower | Room temperature | Comparative example |
| 22 | A | 60 | 8.5 | 2.50 | 50 | 4 | 0.5 | Blower | Room temperature | Comparative example |
| 23 | A | 10 | 30.0 | 1.80 | 70 | 4 | 2 | Blower | Room temperature | Comparative example |
| 24 | A | * | 6.0 | 2.10 | 60 | 6 | 1 | Blower | Room temperature | Comparative example |
| 25 | A | 19 | 8.5 | 2.08 | 70 | 15 | 1 | Blower | Room temperature | Comparative example |

* 2.7 g/L of SnCl₄•5H₂O

TABLE 2

| | Sn-containing | Chemical conversion coatings | | | | Amount of Sn |
|---|---|---|---|---|---|---|
| | plating layers | Mass per unit | Mass per unit | | Appearance | oxide coatings |
| | Mass per unit | area of in | area of in | Mass | immediately | and appearance |
| Sample | area of Sn | terms of P | terms of Al | ratio | after | immediately after |
| Nos. | (g/m²) | (mg/m²) | (mg/m²) | (Al/P) | production | production |
| 1 | 2.8 | 3.2 | 1.7 | 0.53 | A | A |
| 2 | 2.8 | 4.5 | 2.4 | 0.53 | A | A |
| 3 | 2.8 | 6.5 | 3.5 | 0.54 | A | A |
| 4 | 2.8 | 9.5 | 5.1 | 0.54 | B | A |
| 5 | 2.8 | 1.8 | 1.0 | 0.56 | A | A |
| 6 | 2.8 | 2.5 | 1.4 | 0.56 | A | A |
| 7 | 2.8 | 3.0 | 1.6 | 0.53 | A | A |
| 8 | 2.8 | 4.0 | 2.2 | 0.55 | A | A |
| 9 | 2.8 | 5.0 | 2.9 | 0.58 | A | A |
| 10 | 2.8 | 5.1 | 3.0 | 0.59 | A | A |
| 11 | 2.8 | 3.2 | 1.7 | 0.53 | A | A |
| 12 | 2.8 | 3.0 | 1.6 | 0.53 | A | A |
| 13 | 2.8 | 1.8 | 1.4 | 0.78 | A | A |
| 14 | 1.1 | 3.3 | 1.8 | 0.55 | A | A |
| 15 | 1.1 | 3.4 | 1.8 | 0.53 | A | A |
| 16 | 0.1 | 3.6 | 1.9 | 0.53 | A | A |
| 17 | 0.1 | 3.7 | 2.0 | 0.54 | A | A |
| 18 | 2.8 | 4.1 | 2.2 | 0.54 | A | A |
| 19 | 2.8 | 2.5 | 0.5 | 0.20 | A | C |
| 20 | 2.8 | 11.0 | 7.6 | 0.69 | D | A |
| 21 | 2.8 | 1.4 | 0.7 | 0.50 | A | D |
| 22 | 2.8 | 12.0 | 6.7 | 0.56 | C | A |
| 23 | 2.8 | 5.4 | 2.9 | 0.54 | A | A |
| 24 | 2.8 | 10.8 | 0.0 | 0.00 | B | D |
| 25 | 2.8 | 140.0 | 65.8 | 0.47 | D | A |

| | Paint adhesion | | | |
|---|---|---|---|---|
| | Immediately | | | |
| Sample | after | After 6 | Corrosion | |
| Nos. | production | months | resistance | Remarks |
| 1 | B | B | A | Inventive example |
| 2 | B | B | A | Inventive example |
| 3 | B | B | A | Inventive example |
| 4 | B | B | B | Inventive example |
| 5 | B | B | A | Inventive example |
| 6 | B | B | A | Inventive example |
| 7 | B | B | A | Inventive example |
| 8 | B | B | A | Inventive example |
| 9 | B | B | A | Inventive example |
| 10 | B | B | A | Inventive example |
| 11 | B | B | A | Inventive example |
| 12 | B | B | A | Inventive example |
| 13 | B | B | A | Inventive example |
| 14 | B | B | A | Inventive example |
| 15 | B | B | A | Inventive example |
| 16 | A | A | B | Inventive example |
| 17 | A | A | B | Inventive example |
| 18 | B | B | A | Inventive example |
| 19 | B | C | C | Comparative example |
| 20 | D | D | C | Comparative example |
| 21 | B | D | B | Comparative example |
| 22 | C | C | C | Comparative example |
| 23 | C | C | C | Comparative example |
| 24 | B | D | A | Comparative example |
| 25 | D | D | D | Comparative example |

### INDUSTRIAL APPLICABILITY

The following sheet can be produced: a tinned steel sheet that is capable of preventing the deterioration of appearance and the reduction of paint adhesion due to the surface oxidation of a tin plating layer without using Cr, which causes environmental problems, and that can be subjected to chemical conversion at low cost. A chemical conversion coating of a tinned steel sheet can be formed at a high line speed of 300 m/minute as is formed by current chromating. This is a great contribution to industry.

1. A method for producing a tinned steel sheet, comprising:
forming an Sn-containing plating layer on at least one surface of a steel sheet with a mass per unit area of Sn is 0.05 to 20 g/m²;
immersing the steel sheet in a chemical conversion solution containing greater than 18 to 200 g/L or less of aluminum phosphate monobasic and which has a pH of 1.5 to 2.4 or cathodically electrolyzing the steel sheet at a current density of 10 A/dm² or less in the chemical conversion solution; and
drying the steel sheet to form a chemical conversion coating.

2. The method according to claim 1, wherein the Sn-containing plating layer is a plating layer consisting of a Sn layer or a plating layer consisting of an Fe—Sn layer and a Sn layer deposited thereon.

3. The method according to claim 1, wherein drying is performed at a temperature of lower than 60° C.

4. The method according to claim 1, wherein cathodic electrolyzing is performed such that the temperature of the chemical conversion solution is adjusted to 70° C. or higher.

5. A tinned steel sheet produced by the method according to claim 1.

6. The tinned steel sheet according to claim 5, wherein the chemical conversion coating has a mass per unit area of 1.5 to 10 mg/m² in terms of P and the mass ratio (Al/P) of Al to P in the chemical conversion coating is 0.20 to 0.87.

7. A chemical conversion solution having a pH of 1.5 to 2.4, containing greater than 18 to 200 g/L or less of aluminum phosphate monobasic

8. The method according to claim 2, wherein drying is performed at a temperature of lower than 60° C.

9. The method according to claim 2, wherein cathodic electrolyzing is performed such that the temperature of the chemical conversion solution is adjusted to 70° C. or higher.

10. The method according to claim 3, wherein cathodic electrolyzing is performed such that the temperature of the chemical conversion solution is adjusted to 70° C. or higher.

11. A tinned steel sheet produced by the method according to claim 2.

12. A tinned steel sheet produced by the method according to claim 3.

13. A tinned steel sheet produced by the method according to claim 4.
